(19) United States
(12) Patent Application Publication
(10) Pub. No.: US 2025/0273673 A1
(43) Pub. Date: Aug. 28, 2025

(54) HALOGENATED ALL-SOLID-STATE BATTERY MATERIAL AND PREPARATION METHOD AND APPLICATION THEREOF

(71) Applicant: UNIVERSITY OF SCIENCE AND TECHNOLOGY OF CHINA, Hefei (CN)

(72) Inventors: Cheng MA, Hefei (CN); Kai WANG, Hefei (CN)

(73) Assignee: UNIVERSITY OF SCIENCE AND TECHNOLOGY OF CHINA, Hefei (CN)

(21) Appl. No.: 18/858,759

(22) PCT Filed: Aug. 9, 2023
(86) PCT No.: PCT/CN2023/111920

§ 371 Date: Oct. 22, 2024

(30) Foreign Application Priority Data
Aug. 16, 2022 (CN) 202210979868.5

(51) Int. Cl. H01M 4/58; C01G 23/00; C01G 25/00; C01G 53/82; H01M 10/0562

(52) U.S. Cl. CPC H01M 4/582; C01G 23/002; C01G 23/005; C01G 25/006; C01G 53/82; H01M 10/0562; C01P 2002/72; C01P 2006/40; H01M 2300/008

(57) ABSTRACT

A halogenated all-solid-state battery material and a preparation method and application thereof are provided. A general chemical formula of the halogenated all-solid-state battery material is AₓM_{y}X_{z}Y_{b}, wherein A contains Li or Na; M contains one or more of Mg, Al, Si, P, Ca, Ti, V, Cr, Mn, Fe, Co, Ni, Cu, Zn, Ga, Zr and Nb; X contains one or more of F, Cl, Br and I; Y contains O and/or S; and wherein 1≤x≤4, 0.5≤y≤1, 3≤z≤8, and 0≤b≤3. The material has good ionic conductivity, variable valence of M cation and deformability, which enables the material to meet the various requirements as a positive electrode, a negative electrode and a solid electrolyte of an all-solid-state battery and have excellent electrochemical performance.

### CROSS REFERENCE TO THE RELATED APPLICATIONS

This application is the national phase entry of International Application No. PCT/CN2023/111920, filed on Aug. 9, 2023, which is based upon and claims priority to Chinese Patent Application No. 202210979868.5, filed on Aug. 16, 2022, the entire contents of which are incorporated herein by reference.

### TECHNICAL FIELD

The present disclosure relates to the technical field of all-solid-state battery materials, and in particular, to a halogenated all-solid-state battery material and a preparation method and application thereof.

### BACKGROUND

As the next generation of energy storage technology, all-solid-state batteries are expected to solve the safety problems of commercial lithium-ion batteries and further improve energy density. All-solid-state batteries adopt a structure similar to that of commercial lithium-ion batteries, i.e., materials with different functions are used as positive electrodes, negative electrodes and solid electrolytes respectively. The improvement of energy density and cycle stability of all-solid-state batteries depends largely on the cathode materials, but these cathode materials are currently extremely rigid oxides. When these oxides are used as cathode materials for all-solid-state batteries, they have to be combined with a large number of deformable solid electrolytes (such as halides, sulfides, etc.) to form composite electrodes to meet the needs of ion transport. This not only reduces the energy density of the all-solid-state battery, but also the side reaction between the electrode material and the solid electrolyte material in the composite electrode will further reduce its cycle stability.

In view of this, it is urgent to optimize and develop all-solid-state batteries with new structures, which requires further development of battery material functions. However, the function of commercial lithium-ion battery materials is relatively simple. The positive electrode, negative electrode and electrolyte are all acted by the corresponding functional materials, which greatly limits the optimization of battery structure. Scientists have also tried to design a battery material with multiple functions of positive electrode, negative electrode and electrolyte, but this ideal multi-functional material has not been found yet. The difficulty is that this new multifunctional battery material should simultaneously satisfy high ionic conductivity, good deformability and reversible redox ability with non-lithium/sodium cations. Only in this way can it act as at least two of the positive electrode, negative electrode and electrolyte of the all-solid-state batteries.

Therefore, how to obtain an all-solid-state battery material with multiple functions of positive electrode, negative electrode and electrolyte is a technical problem to be solved at present.

### SUMMARY

An objective of the present disclosure is to provide a halogenated all-solid-state battery material and preparation method and applications thereof, to solve the technical problems that the prior art cannot obtain a multi-functional battery material that simultaneously satisfies high ion conductivity, good deformability, and reversible oxidation-reduction ability of non-lithium/sodium cations.

In order to achieve the above objective, the present disclosure adopts the following technical solutions.

The present disclosure provides a halogenated all-solid-state battery material, a general chemical formula of the halogenated all-solid-state battery material is AₓM_{y}X_{z}Y_{b}, wherein A contains Li or Na; M contains one or more of Mg, Al, Si, P, Ca, Ti, V, Cr, Mn, Fe, Co, Ni, Cu, Zn, Ga, Zr and Nb; X contains one or more of F, Cl, Br and I; Y contains O and/or S; and wherein 1≤x≤4, 0.5≤y≤1, 3≤z≤8, and 0≤b≤3.

Further, a chemical formula of the halogenated all-solid-state battery material is selected from one of the following chemical formulas:
Li₃TiCl₆, Li₄TiCl₆, Li₃TiCl₅O_{0.5}, Li₃TiCl₅F, Li₃Ti_{0.75}Al_{0.25}Cl₆, Li₄NiCl₆, Li₃ZrCl₆, Li₃Zr_{0.75}Ti_{0.25}Cl₆, Li_{3.25}Zr_{0.75}Mg_{0.25}Cl₆, and Li_{2.5}Zr_{0.75}Ca_{0.25}Cl₆.

The present disclosure provides a preparation method for the halogenated all-solid-state battery material, comprising the following steps:
taking and mixing raw materials with a stoichiometric ratio, and then performing ball milling, to obtain the halogenated all-solid-state battery material.

Further, a ball material ratio of the ball milling is (10-15):1, a rotation speed of the ball milling is 500-600 rpm, and a time of the ball milling is 20-50 h.

Further, performing an annealing treatment after the ball milling.

Further, a temperature of the annealing treatment is 300-500° C., and a time of the annealing treatment is 4-6 h.

The present disclosure provides application of the halogenated all-solid-state battery material in preparing an all-solid-state battery.

The beneficial effects of the present disclosure are:
the halogenated all-solid-state battery material obtained by the present disclosure not only has an ionic conductivity of up to 1 mS/cm, but also has good deformability, and the M element has a reversible redox ability. The good deformation ability ensures that the battery material can be simply cold pressed into an all-solid-state battery. The battery material, as a positive and negative electrode, no longer needs to add a deformable ion conductive agent that does not provide energy, which can increase the energy density of the battery. At the same time, the high lithium-ion conductivity ensures the high rate performance of the battery.

The successful development of the halogenated all-solid-state battery material of the present disclosure contributes to optimizing the structure of the all-solid-state battery, improving the energy density of the all-solid-state battery, and providing a new idea for the industrialization of the all-solid-state battery.

### BRIEF DESCRIPTION OF THE DRAWINGS

FIG. 1 is an X-ray diffraction spectrum of a low-crystalline Li₃TiCl₆ material prepared by Embodiment 1;

FIG. 2 is an electrochemical impedance spectroscopy of a low-crystalline Li₃TiCl₆ material prepared by Embodiment 1;

FIG. 3 is a direct current polarization spectrum of a low-crystalline Li₃TiCl₆ material prepared by Embodiment 1;

FIG. 4 is an X-ray diffraction spectrum of a high-crystalline Li₃TiCl₆ material prepared by Embodiment 1;

FIG. 5 is an electrochemical impedance spectroscopy of a high-crystalline Li₃TiCl₆ material prepared by Embodiment 1;

FIG. 6 is a direct current polarization spectrum of a high-crystalline Li₃TiCl₆ material prepared by Embodiment 1;

FIG. 7 is a charge-discharge curve of a high-crystalline Li₃TiCl₆ material prepared by Embodiment 1 as a cathode material;

FIG. 8 is a charge-discharge curve of a single material all-solid-state battery assembled by a high-crystalline Li₃TiCl₆ material prepared by Embodiment 1;

FIG. 9 is an X-ray diffraction spectrum of a low-crystalline Li₄TiCl₆ material prepared by Embodiment 2;

FIG. 10 is an electrochemical impedance spectroscopy of a low-crystalline Li₄TiCl₆ material prepared by Embodiment 2;

FIG. 11 is a direct current polarization spectrum of a low-crystalline Li₄TiCl₆ material prepared by Embodiment 2;

FIG. 12 is an X-ray diffraction spectrum of a low-crystalline Li₃TiCl₅O_{0.5} material prepared by Embodiment 3;

FIG. 13 is an electrochemical impedance spectroscopy of a low-crystalline Li₃TiCl₅O_{0.5} material prepared by Embodiment 3;

FIG. 14 is a direct current polarization spectrum of a low-crystalline Li₃TiCl₅O_{0.5} material prepared by Embodiment 3;

FIG. 15 is an X-ray diffraction spectrum of a high-crystalline Li₃TiCl₅O_{0.5} material prepared by Embodiment 3;

FIG. 16 is an electrochemical impedance spectroscopy of a high-crystalline Li₃TiCl₅O_{0.5} material prepared by Embodiment 3;

FIG. 17 is a direct current polarization spectrum of a high-crystalline Li₃TiCl₅O_{0.5} material prepared by Embodiment 3;

FIG. 18 is an X-ray diffraction spectrum of a low-crystalline Li₃TiCl₅F material prepared by Embodiment 4;

FIG. 19 is an electrochemical impedance spectroscopy of a low-crystalline Li₃TiCl₅F material prepared by Embodiment 4;

FIG. 20 is a direct current polarization spectrum of a low-crystalline Li₃TiCl₅F material prepared by Embodiment 4;

FIG. 21 is an X-ray diffraction spectrum of a low-crystalline Li₃Ti_{0.75}Al_{0.25}Cl₆ material prepared by Embodiment 5;

FIG. 22 is an electrochemical impedance spectroscopy of a low-crystalline Li₃Ti_{0.75}Al_{0.25}Cl₆ material prepared by Embodiment 5;

FIG. 23 is a direct current polarization spectrum of a low-crystalline Li₃Ti_{0.75}Al_{0.25}Cl₆ material prepared by Embodiment 5;

FIG. 24 is an X-ray diffraction spectrum of a high-crystalline Li₃Ti_{0.75}Al_{0.25}Cl₆ material prepared by Embodiment 5;

FIG. 25 is an electrochemical impedance spectroscopy of a high-crystalline Li₃Ti_{0.75}Al_{0.25}Cl₆ material prepared by Embodiment 5;

FIG. 26 is a direct current polarization spectrum of a high-crystalline Li₃Ti_{0.75}Al_{0.25}Cl₆ material prepared by Embodiment 5;

FIG. 27 is an X-ray diffraction spectrum of a low-crystalline Li₄NiCl₆ material prepared by Embodiment 6;

FIG. 28 is an electrochemical impedance spectroscopy of a low-crystalline Li₄NiCl₆ material prepared by Embodiment 6;

FIG. 29 is a direct current polarization spectrum of a low-crystalline Li₄NiCl₆ material prepared by Embodiment 6;

FIG. 30 is a charge-discharge curve of a low-crystalline Li₄NiCl₆ material prepared by Embodiment 6 as an electrode material in a voltage range of 3.16-5 V vs. Li/Li+;

FIG. 31 is a charge-discharge curve of a low-crystalline Li₄NiCl₆ material prepared by Embodiment 6 as an electrode material in a voltage range of 1-3 V vs. Li/Li+;

FIG. 32 is an X-ray diffraction spectrum of a low-crystalline Li₃ZrCl₆ material prepared by Embodiment 7;

FIG. 33 is an electrochemical impedance spectroscopy of a low-crystalline Li₃ZrCl₆ material prepared by Embodiment 7;

FIG. 34 is a direct current polarization spectrum of a low-crystalline Li₃ZrCl₆ material prepared by Embodiment 7;

FIG. 35 is an X-ray diffraction spectrum of a low-crystalline Li₃Zr_{0.75}Ti_{0.25}Cl₆ material prepared by Embodiment 8;

FIG. 36 is an electrochemical impedance spectroscopy of a low-crystalline Li₃Zr_{0.75}Ti_{0.25}Cl₆ material prepared by Embodiment 8;

FIG. 37 is a direct current polarization spectrum of a low-crystalline Li₃Zr_{0.75}Ti_{0.25}Cl₆ material prepared by Embodiment 8;

FIG. 38 is an X-ray diffraction spectrum of a low-crystalline Li_{3.25}Zr_{0.75}Mg_{0.25}Cl₆ material prepared by Embodiment 9;

FIG. 39 is an electrochemical impedance spectroscopy of a low-crystalline Li_{3.25}Zr_{0.75}Mg_{0.25}Cl₆ material prepared by Embodiment 9;

FIG. 40 is a direct current polarization spectrum of a low-crystalline Li_{3.25}Zr_{0.75}Mg_{0.25}Cl₆ material prepared by Embodiment 9;

FIG. 41 is an X-ray diffraction spectrum of a low-crystalline Li_{2.5}Zr_{0.75}Ca_{0.25}Cl₆ material prepared by Embodiment 10;

FIG. 42 is an electrochemical impedance spectroscopy of a low-crystalline Li_{2.5}Zr_{0.75}Ca_{0.25}Cl₆ material prepared by Embodiment 10; and

FIG. 43 is a direct current polarization spectrum of a low-crystalline Li_{2.5}Zr_{0.75}Ca_{0.25}Cl₆ material prepared by Embodiment 10.

### DETAILED DESCRIPTION OF THE EMBODIMENTS

The present disclosure provides a halogenated all-solid-state battery material, a general chemical formula of the halogenated all-solid-state battery material is AₓM_{y}X_{z}Y_{b}, wherein A contains Li or Na; M contains one or more of Mg, Al, Si, P, Ca, Ti, V, Cr, Mn, Fe, Co, Ni, Cu, Zn, Ga, Zr and Nb; X contains one or more of F, Cl, Br and I; Y contains O and/or S; and wherein 1≤x≤4, 0.5≤y≤1, 3≤z≤8, and 0≤b≤3.

In the present disclosure, wherein x, y, z and b are preferably: 2≤x≤3, 0.6≤y≤0.9, 4≤z≤7, and 1≤b≤2; and further preferably: 2.1≤x≤2.6, 0.7≤y≤0.8, 5≤z≤6, and 1.2≤b≤1.8.

In the present disclosure, a chemical formula of the halogenated all-solid-state battery material is selected from one of the following chemical formulas:
Li₃TiCl₆, Li₄TiCl₆, Li₃TiCl₅O_{0.5}, Li₃TiCl₅F, Li₃Ti_{0.75}Al_{0.25}Cl₆, Li₄NiCl₆, Li₃ZrCl₆, Li₃Zr_{0.75}Ti_{0.25}Cl₆, Li_{3.25}Zr_{0.75}Mg_{0.25}Cl₆, and Li_{2.5}Zr_{0.75}Ca_{0.25}Cl₆.

The present disclosure provides a preparation method for the halogenated all-solid-state battery material, comprising the following steps:
taking and mixing raw materials with a stoichiometric ratio, and then performing ball milling, to obtain the halogenated all-solid-state battery material.

In the present disclosure, a ball material ratio of the ball milling is (10-15):1, a rotation speed of the ball milling is 500-600 rpm, and a time of the ball milling is 20-50 h; preferably, a ball material ratio of the ball milling is 11-14:1, a rotation speed of the ball milling is 520-580 rpm, and a time of the ball milling is 24-45 h; and further preferably, a ball material ratio of the ball milling is 12-13:1, a rotation speed of the ball milling is 520-550 rpm, and a time of the ball milling is 30-40 h.

In the present disclosure, performing an annealing treatment after the ball milling.

In the present disclosure, a temperature of the annealing treatment is 300-500° C., and a time of the annealing treatment is 4-6 h; preferably, a temperature of the annealing treatment is 350-450° C., and a time of the annealing treatment is 4-5 h; and further preferably, a temperature of the annealing treatment is 400° C., and a time of the annealing treatment is 5 h.

In the present disclosure, the material after annealing treatment is a high crystal material, and the material without annealing treatment is a low crystal material.

The present disclosure provides application of the halogenated all-solid-state battery material in preparing an all-solid-state battery.

The halogenated all-solid-state battery material can be used as one or more of the positive electrode, negative electrode and solid electrolyte of the all-solid-state battery.

In the following, the technical solutions provided by the present disclosure are described in detail in combination with the embodiments, but they cannot be understood as limiting the scope of protection of the present disclosure.

### Embodiment 1

Preparation of a Halogenated All-Solid-State Li₃TiCl₆ Material

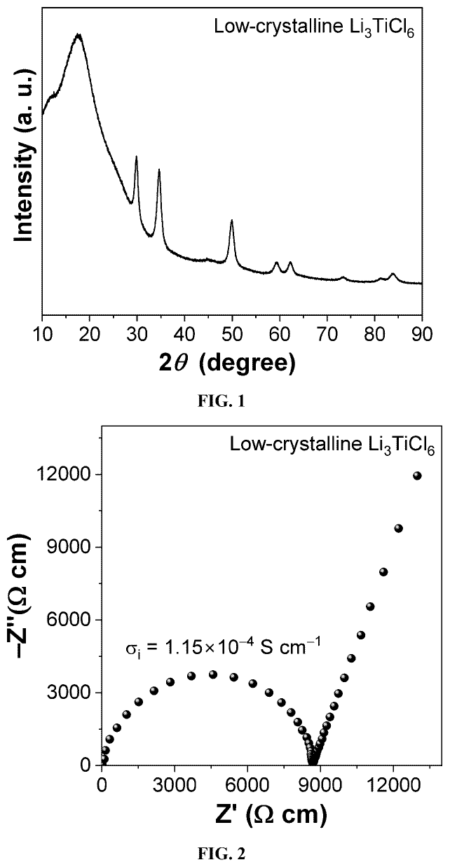

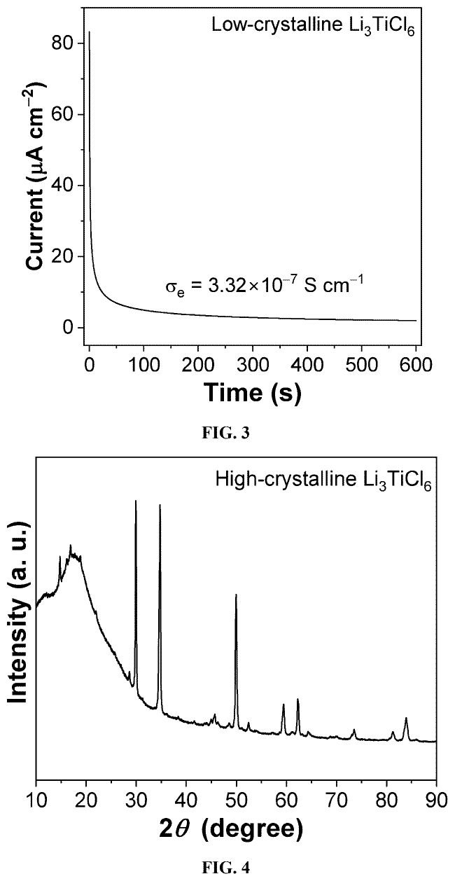

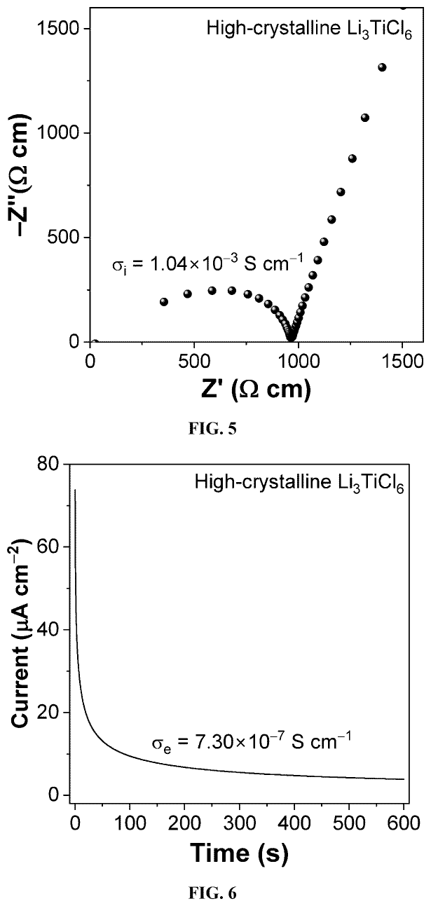

In an argon-protected glove box (a water oxygen content was less than 0.01 ppm), LiCl and TiCl₃ were weighed in a stoichiometric ratio, respectively, placed in an 80 mL silicon nitride ball mill tank equipped with 5 mm diameter zirconia ball mill beads (a mass ratio of ball and material was 12:1), and ball milled for 24 hours at 600 r/min in a high-energy ball mill Pulverisette 7 of the German Fritsch Company after sealing. A low-crystalline sample was unannealed after ball milling, a high-crystalline sample was sealed in a quartz tube and annealed at 300°° C. for 5 hours, and their X-ray diffraction spectrum, electrochemical impedance spectroscopy and direct current polarization spectrum were shown in FIGS. 1-6, respectively. The results showed that a space group of the Li₃TiCl₆ material was C2/m, an ionic conductivity at room temperature (σi) of a low-crystalline Li₃TiCl₆ material was 1.15×10⁻⁴ S/cm, and an electronic conductivity at room temperature (σe) was 3.32×10⁻⁷ S/cm; an ionic conductivity at room temperature (σi) of a high-crystalline Li₃TiCl₆ material was as high as 1.04×10⁻³ S/cm, and an electronic conductivity at room temperature was 7.30×10⁻⁷ S/cm. The ionic conductivity and electronic conductivity were measured by simply cold pressing the battery material into sheets, indicating that the Li₃TiCl₆ material had good deformability; and a fact that the ionic conductivity was three orders of magnitude higher than the electronic conductivity proved that the Li₃TiCl₆ material was a pure ionic conductor that might be used as a solid electrolyte. A transition metal element Ti generally had combined states of Ti²⁺, Ti³⁺ and Ti⁴⁺, which had a potential redox ability as a cathode material.

The high-crystalline Li₃TiCl₆ (LTC) with a mass ratio of 95:5 was uniformly mixed with carbon black (C) as a composite cathode, Li₂ZrCl₆ (LZC) and Li₆PS₅Cl (LPSCl) were used as solid electrolytes, and a Li-In alloy was used as a negative electrode to assemble an all-solid-state battery, to verify the feasibility of Li₃TiCl₆ as a cathode material, as shown in FIG. 7. The results showed that the all-solid-state battery had an initial coulombic efficiency of no less than 97.3% and an initial discharge specific capacity of 92.5 mAh·g⁻¹, which proved that Li₃TiCl₆ might be used as a 3V insertion cathode material.

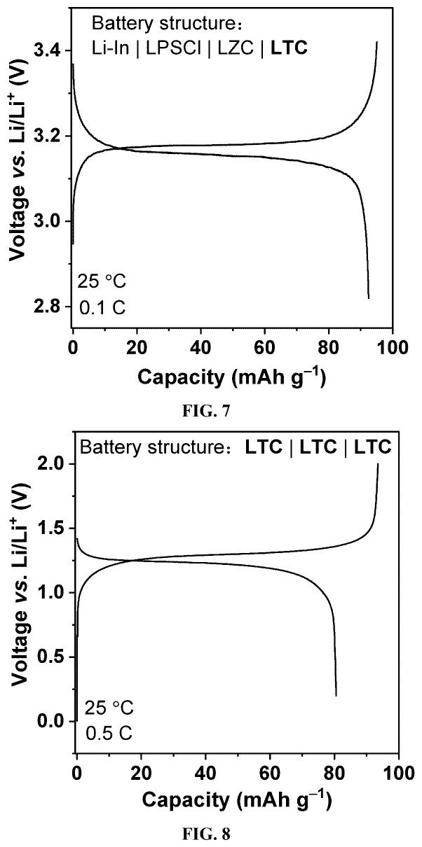

In an argon-protected glove box (a water oxygen content was less than 0.01 ppm), the high-crystalline Li₃TiCl₆ (LTC) and carbon black (C) with a mass ratio of 95:5 were taken, then mixed evenly as a composite positive electrode and a composite negative electrode. Then a single material all-solid-state battery was assembled according to a structure of Li₃TiCl₆+C|Li₃TiCl₆| Li₃TiCl₆+C, and then electrochemical tests were performed, as shown in FIG. 8. The results showed that the Li₃TiCl₆ material had an initial coulombic efficiency of not less than 86.1% and an initial discharge specific capacity of 80.5 mAh·g⁻¹, which proved that the Li₃TiCl₆ material might be used as the positive electrode, negative electrode and solid electrolyte of all-solid-state battery. It was worth noting that Li₃TiCl₆ might be replaced by any of the multi-functional halides contained in the present disclosure to assemble the single-material all-solid-state battery.

Embodiment 2

Preparation of a Halogenated All-Solid-State Li₄TiCl₆ Material

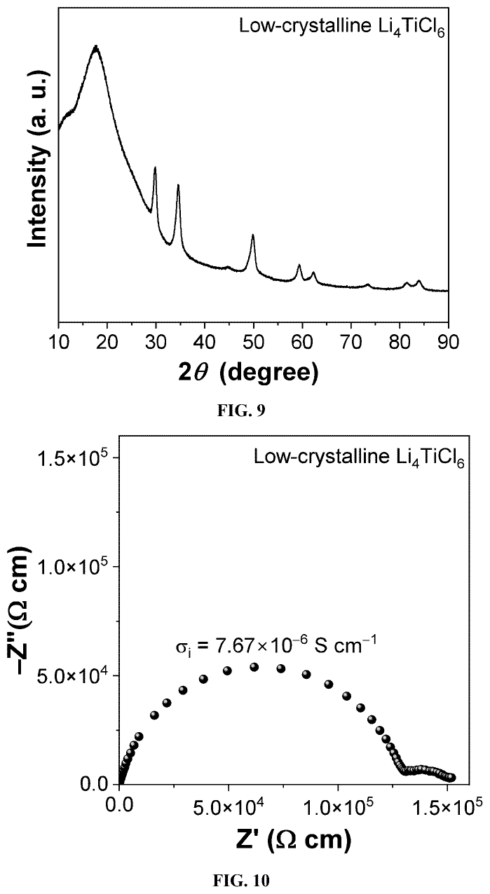

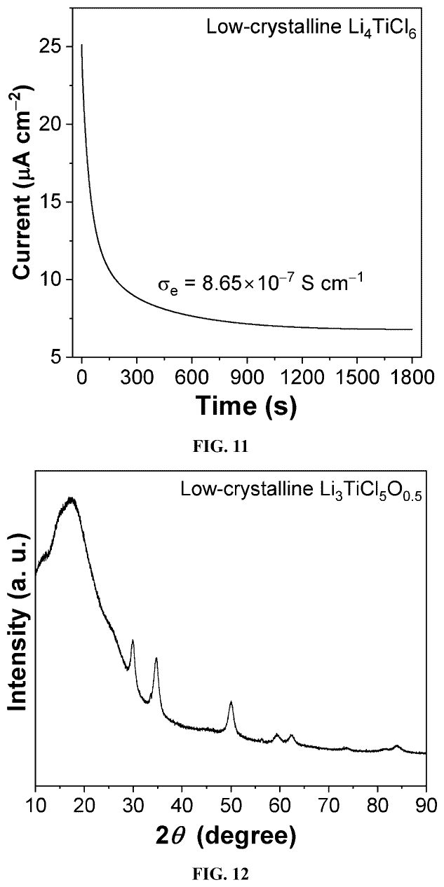

In an argon-protected glove box (a water oxygen content was less than 0.01 ppm), LiCl, TiCl3 and Ti powder were weighed in a stoichiometric ratio, respectively, placed in an 80 mL silicon nitride ball mill tank equipped with 5 mm diameter zirconia ball mill beads (a mass ratio of ball and material was 12:1), and ball milled for 24 hours at 600 r/min in a high-energy ball mill Pulverisette 7 of the German Fritsch Company after sealing. The X-ray diffraction spectrum, electrochemical impedance spectroscopy and direct current polarization spectrum of a low-crystalline Li4TiCl6 material after ball milling were shown in FIGS. 9-11, respectively. The results showed that a space group of the Li₄TiCl₆ material was C2/m, an ionic conductivity at room temperature of the low-crystalline Li₄TiCl₆ material was 7.67×10⁻⁶ S/cm, and an electronic conductivity at room temperature was 8.65×10⁻⁷ S/cm; and the ionic conductivity and electronic conductivity were measured by simply cold pressing the battery material into sheets, indicating that the Li₄TiCl₆ material had good deformability. A transition metal element Ti generally had combined states of Ti²⁺, Ti³⁺ and Ti⁴⁺, which had a potential redox ability as a cathode material.

### Embodiment 3

Preparation of a Halogenated All-Solid-State Li₃TiCl₅O_{0.5} Material

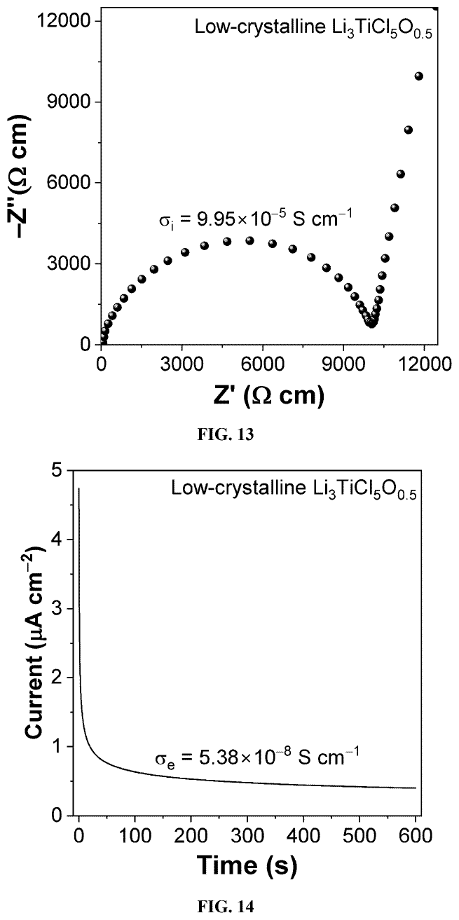

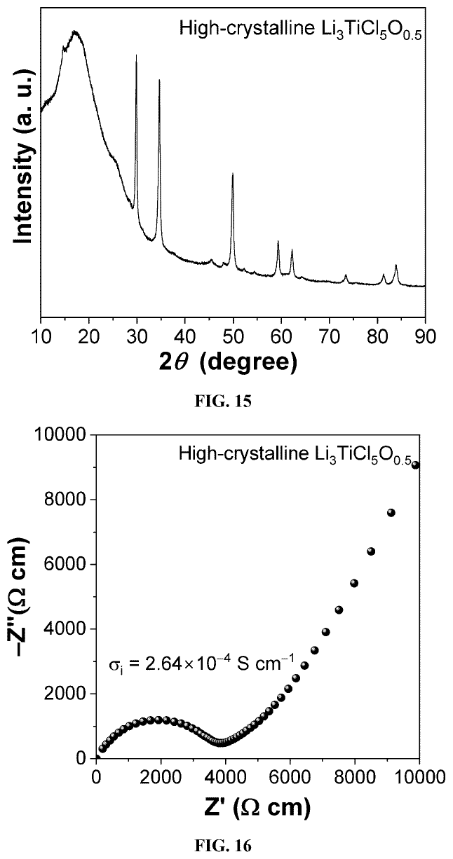

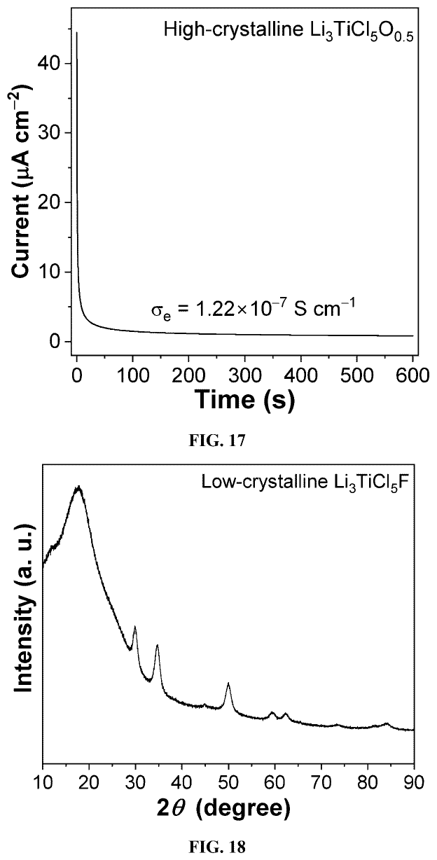

In an argon-protected glove box (a water oxygen content was less than 0.01 ppm), LiCl, TiCl₃ and Li₂O were weighed in a stoichiometric ratio, respectively, placed in an 80 mL silicon nitride ball mill tank equipped with 5 mm diameter zirconia ball mill beads (a mass ratio of ball and material was 12:1), and ball milled for 24 hours at 600 r/min in a high-energy ball mill Pulverisette 7 of the German Fritsch Company after sealing. A low-crystalline sample was unannealed after ball milling, a high-crystalline sample was sealed in a quartz tube and annealed at 300° C. for 5 hours, and their X-ray diffraction spectrum, electrochemical impedance spectroscopy and direct current polarization spectrum were shown in FIGS. 12-17, respectively. The results showed that a space group of the Li₃TiCl₅O_{0.5} material was C2/m, an ionic conductivity at room temperature of a low-crystalline Li₃TiCl₅O_{0.5} material was 9.95×10⁻⁵ S/cm, and an electronic conductivity at room temperature was 5.38×10⁻⁸ S/cm; and an ionic conductivity at room temperature of a high-crystalline Li₃TiCl₅O_{0.5} material was 2.64×10⁻⁴ S/cm, and an electronic conductivity at room temperature was 1.22×10⁻⁷ S/cm. The ionic conductivity and electronic conductivity were measured by simply cold pressing the battery material into sheets, indicating that the Li₃TiCl₅O_{0.5} material had good deformability; and a fact that the ionic conductivity was three orders of magnitude higher than the electronic conductivity proved that the Li₃TiCl₅O_{0.5} material was a pure ionic conductor that might be used as a solid electrolyte. A transition metal element Ti generally had combined states of Ti²⁺, Ti³⁺ and Ti⁴⁺, which had a potential redox ability as a cathode material.

### Embodiment 4

Preparation of a Halogenated All-Solid-State Li₃TiCl₅F Material

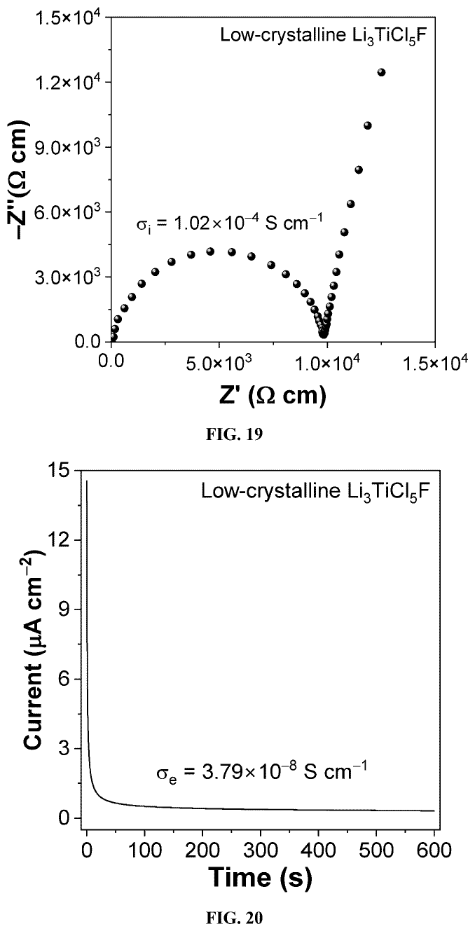

In an argon-protected glove box (a water oxygen content was less than 0.01 ppm), LiCl, TiCl₃ and LiF were weighed in a stoichiometric ratio, respectively, placed in an 80 mL silicon nitride ball mill tank equipped with 5 mm diameter zirconia ball mill beads (a mass ratio of ball and material was 12:1), and ball milled for 24 hours at 600 r/min in a high-energy ball mill Pulverisette 7 of the German Fritsch Company after sealing. The X-ray diffraction spectrum, electrochemical impedance spectroscopy and direct current polarization spectrum of a low-crystalline Li₃TiCl₅F material after ball milling were shown in FIGS. 18-20, respectively. The results showed that a space group of the Li₃TiCl₅F material was C2/m, an ionic conductivity at room temperature of the low-crystalline Li₃TiCl₅F material was 1.02×10⁻⁴ S/cm, and an electronic conductivity at room temperature was 3.79×10⁻⁸ S/cm. The ionic conductivity and electronic conductivity were measured by simply cold pressing the battery material into sheets, indicating that the Li₃TiCl₅F material had good deformability; and a fact that the ionic conductivity was four orders of magnitude higher than the electronic conductivity proved that the Li₃TiCl₅F material was a pure ionic conductor that might be used as a solid electrolyte. A transition metal element Ti generally had combined states of Ti²⁺, Ti³⁺ and Ti⁴⁺, which had a potential redox ability as a cathode material.

### Embodiment 5

Preparation of a Halogenated All-Solid-State Li₃Ti_{0.75}Al_{0.25}Cl₆ Material

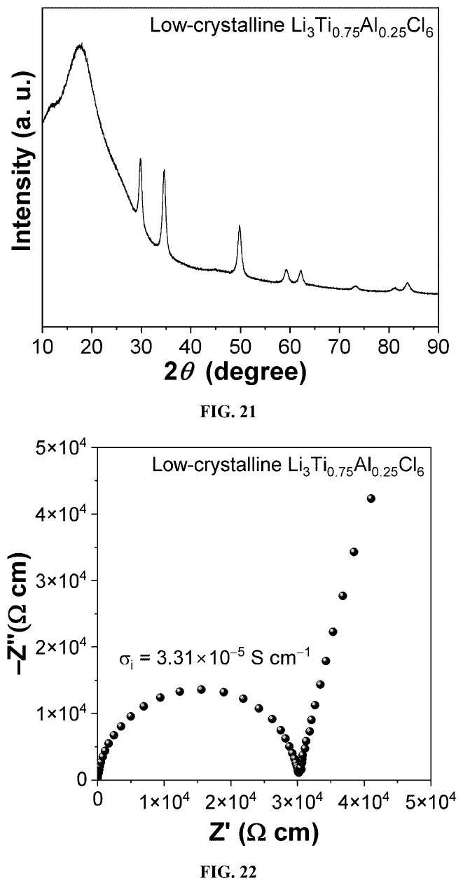

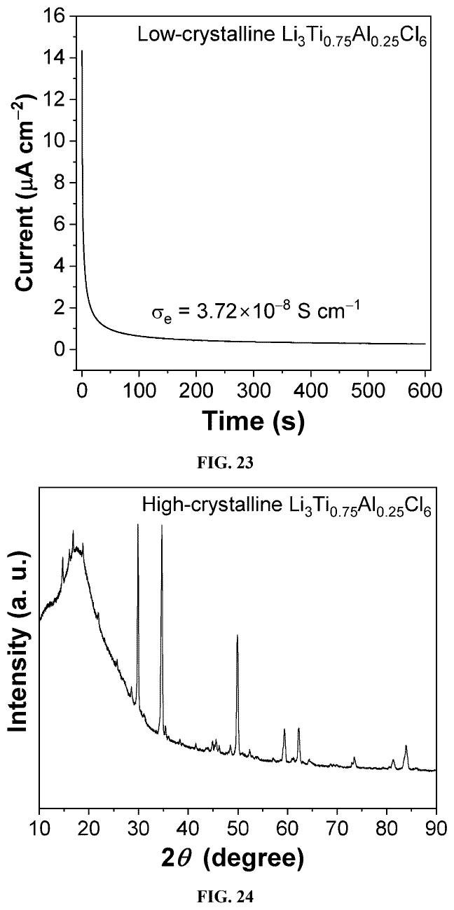

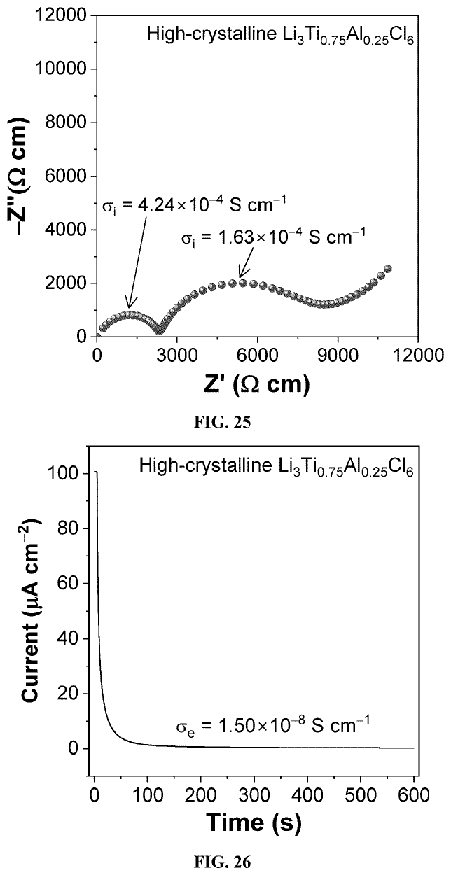

In an argon-protected glove box (a water oxygen content was less than 0.01 ppm), LiCl, TiCl₃ and AlCl₃ were weighed in a stoichiometric ratio, respectively, placed in an 80 mL silicon nitride ball mill tank equipped with 5 mm diameter zirconia ball mill beads (a mass ratio of ball and material was 12:1), and ball milled for 24 hours at 600 r/min in a high-energy ball mill Pulverisette 7 of the German Fritsch Company after sealing. A low-crystalline sample was unannealed after ball milling, a high-crystalline sample was sealed in a quartz tube and annealed at 300° C. for 5 hours, and their X-ray diffraction spectrum, electrochemical impedance spectroscopy and direct current polarization spectrum were shown in FIGS. 21-26, respectively. The results showed that a space group of the Li₃Ti_{0.75}Al_{0.25}Cl₆ material was C2/m, an ionic conductivity at room temperature of a low-crystalline Li₃Ti_{0.75}Al_{0.25}Cl₆ material was 3.31×10⁻⁵ S/cm, and an electronic conductivity at room temperature was 3.72×10⁻⁸ S/cm; and an ionic conductivity at room temperature of a high-crystalline Li₃Ti_{0.75}Al_{0.25}Cl₆ material was 4.24×10⁻⁴ S/cm, a grain boundary ionic conductivity was 1.63×10⁻⁴ S/cm, and an electronic conductivity at room temperature was 1.50×10⁻⁸ S/cm. The ionic conductivity and electronic conductivity were measured by simply cold pressing the battery material into sheets, indicating that the Li₃Ti_{0.75}Al_{0.25}Cl₆ material had good deformability; and a fact that the ionic conductivity was four orders of magnitude higher than the electronic conductivity proved that the Li₃TiCl₆ material was a pure ionic conductor that might be used as a solid electrolyte. A transition metal element Ti generally had combined states of Ti²⁺, Ti³⁺ and Ti⁴⁺, which had a potential redox ability as a cathode material.

### Embodiment 6

Preparation of a Halogenated All-Solid-State Li₄NiCl₆ Material

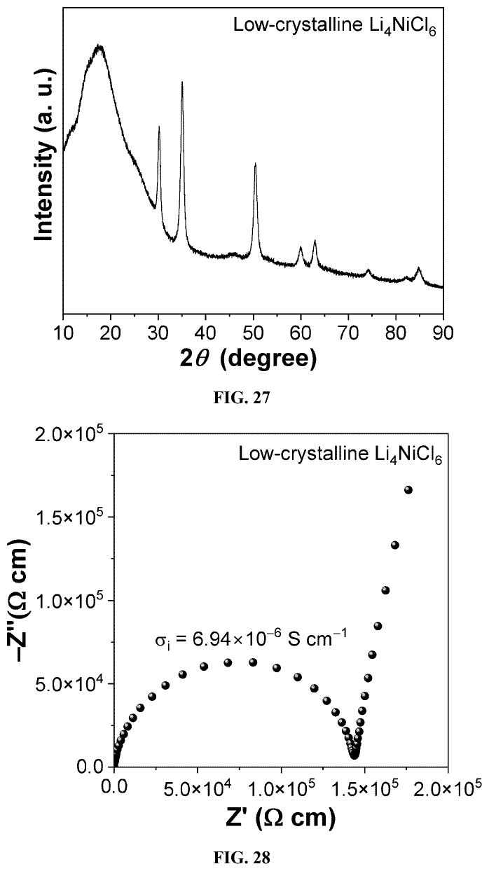

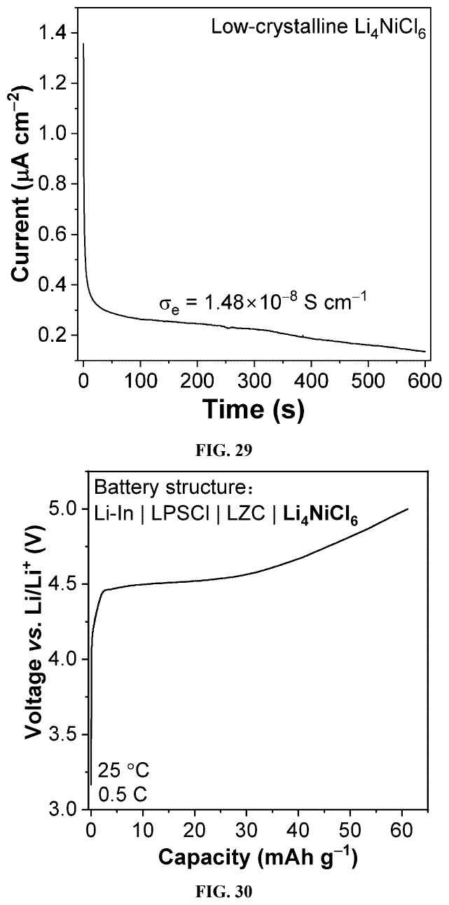

In an argon-protected glove box (a water oxygen content was less than 0.01 ppm), LiCl and NiCl₂ were weighed in a stoichiometric ratio, respectively, placed in an 80 mL silicon nitride ball mill tank equipped with 5 mm diameter zirconia ball mill beads (a mass ratio of ball and material was 12:1), and ball milled for 24 hours at 600 r/min in a high-energy ball mill Pulverisette 7 of the German Fritsch Company after sealing. The X-ray diffraction spectrum, electrochemical impedance spectroscopy and direct current polarization spectrum of the Li₄NiCl₆ material after ball milling were shown in FIGS. 27-29, respectively. The results showed that a space group of the Li₄NiCl₆ material was C2/m, an ionic conductivity at room temperature of a low-crystalline Li₄NiCl₆ material was 6.94×10⁻⁶ S/cm, and an electronic conductivity at room temperature was 1.48×10⁻⁸ S/cm. The ionic conductivity and electronic conductivity were measured by simply cold pressing the battery material into sheets, indicating that the Li₄NiCl₆ material had good deformability. A transition metal element Ni generally had combined states of Ni⁺, Ni²⁺ and Ni³⁺, which had a potential redox ability as a cathode material.

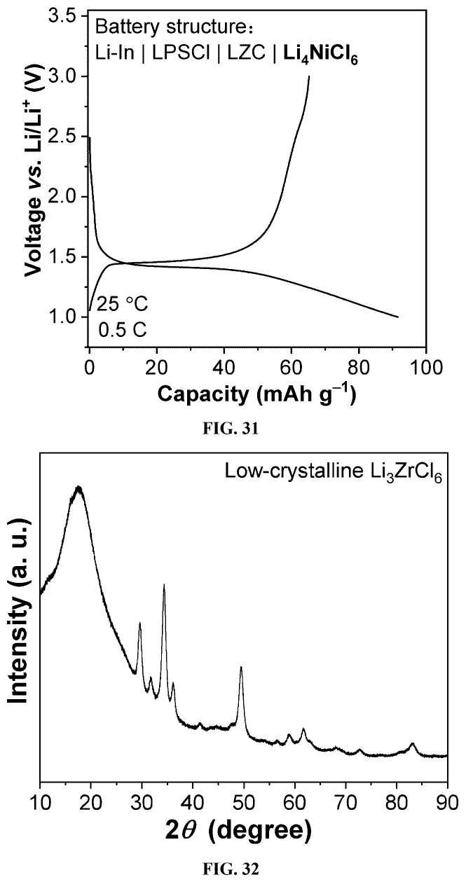

The low-crystalline Li₄NiCl₆, LZC and carbon black (C) with a mass ratio of 50:45:5 were used as a composite cathode, LZC and LPSCl were used as solid electrolytes, and a Li—In alloy was used as a negative electrode to assemble an all-solid-state battery, to verify the feasibility of the Li₄NiCl₆ material as an electrode material, as shown in FIG. 30 and FIG. 31. The results showed that the Li₄NiCl₆ material might be charged and discharged in different voltage ranges, and might be used as a positive electrode, a negative electrode and an electrolyte material.

### Embodiment 7

Preparation of a Halogenated All-Solid-State Li₃ZrCl₆ Material

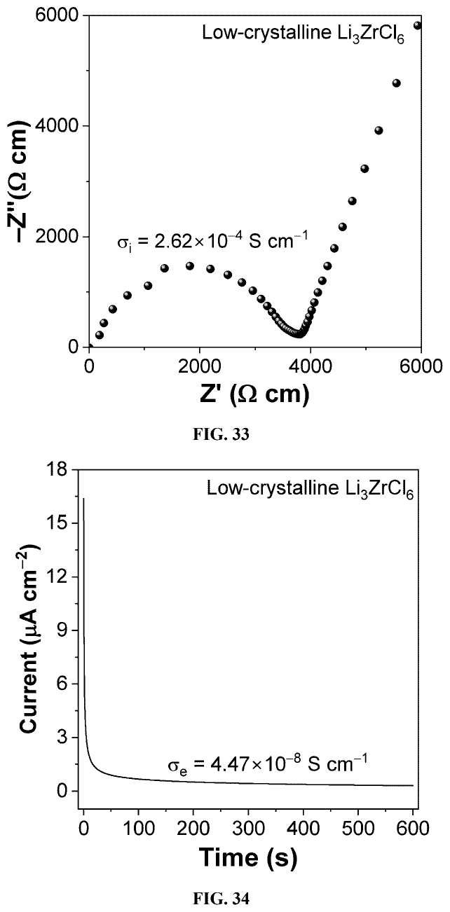

In an argon-protected glove box (a water oxygen content was less than 0.01 ppm), LiCl, ZrCl₄ and Zr powder were weighed in a stoichiometric ratio, respectively, placed in an 80 mL silicon nitride ball mill tank equipped with 5 mm diameter zirconia ball mill beads (a mass ratio of ball and material was 10:1), and ball milled for 45 hours at 500 r/min in a high-energy ball mill Pulverisette 7 of the German Fritsch Company after sealing. The X-ray diffraction spectrum, electrochemical impedance spectroscopy and direct current polarization spectrum of a low-crystalline Li₃ZrCl₆ material after ball milling were shown in FIGS. 32-34, respectively. The results showed that an ionic conductivity at room temperature of the low-crystalline Li₃ZrCl₆ material was 2.62×10⁻⁴ S/cm, and an electronic conductivity at room temperature was 4.47×10⁻⁸ S/cm. The ionic conductivity and electronic conductivity were measured by simply cold pressing the battery material into sheets, indicating that the Li₃ZrCl₆ material had good deformability; and a fact that the ionic conductivity was four orders of magnitude higher than the electronic conductivity proves that the Li₃ZrCl₆ material was a pure ionic conductor that might be used as a solid electrolyte. A transition metal element Zr had combined state of Zr³⁺ and Zr⁴⁺, which had a potential redox ability as a cathode material.

### Embodiment 8

Preparation of a Halogenated All-Solid-State Li₃Zr_{0.75}Ti_{0.25}Cl₆ Material

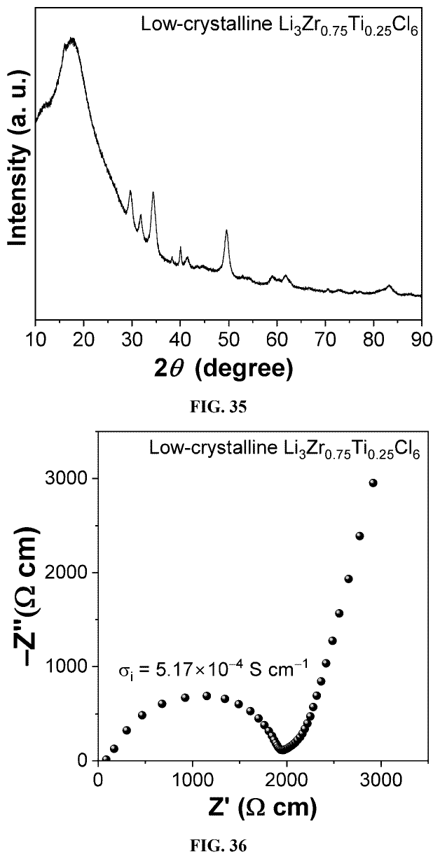

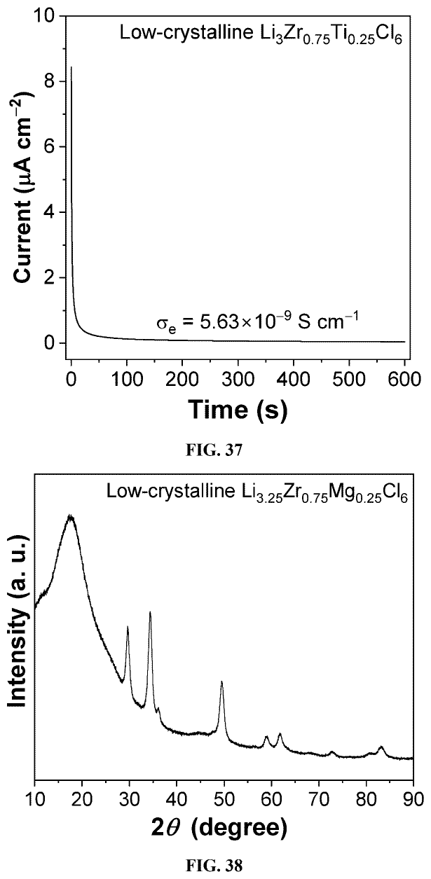

In an argon-protected glove box (a water oxygen content was less than 0.01 ppm), LiCl, ZrCl₄ and Ti powder were weighed in a stoichiometric ratio, respectively, placed in an 80 mL silicon nitride ball mill tank equipped with 5 mm diameter zirconia ball mill beads (a mass ratio of ball and material was 10:1), and ball milled for 45 hours at 500 r/min in a high-energy ball mill Pulverisette 7 of the German Fritsch Company after sealing. The X-ray diffraction spectrum, electrochemical impedance spectroscopy and direct current polarization spectrum of a low-crystalline Li₃Zr_{0.75}Ti_{0.25}Cl₆ material after ball milling were shown in FIGS. 35-37, respectively. The results showed that an ionic conductivity at room temperature of the low-crystalline Li₃Zr_{0.75}Ti_{0.25}Cl₆ material was 5.17×10⁻⁴ S/cm, and an electronic conductivity at room temperature was 5.63×10⁻⁹ S/cm. The ionic conductivity and electronic conductivity were measured by simply cold pressing the battery material into sheets, indicating that the Li₃Zr_{0.75}Ti_{0.25}Cl₆ material had good deformability; and a fact that the ionic conductivity was five orders of magnitude higher than the electronic conductivity proved that the Li₃Zr_{0.75}Ti_{0.25}Cl₆ material was a pure ionic conductor that might be used as a solid electrolyte. A transition metal element Zr had combined states of Zr³⁺ and Zr⁴⁺, and Ti had combined states of Ti²⁺, Ti³⁺ and Ti⁴⁺, which had a potential redox ability as a cathode material.

### Embodiment 9

Preparation of a Halogenated All-Solid-State Li_{3.25}Zr_{0.75}Mg0.25Cl₆ Material

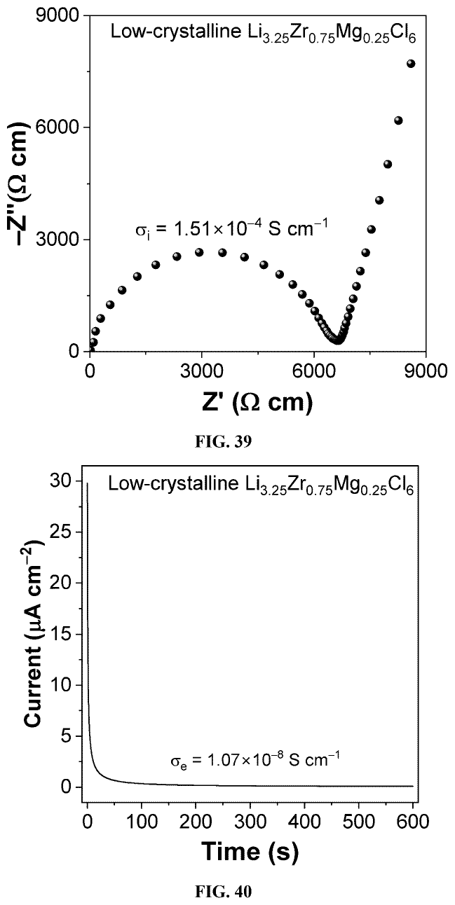

In an argon-protected glove box (a water oxygen content was less than 0.01 ppm), LiCl, ZrCl₄, MgCl₂ and Zr powder were weighed in a stoichiometric ratio, respectively, placed in an 80 mL silicon nitride ball mill tank equipped with 5 mm diameter zirconia ball mill beads (a mass ratio of ball and material was 10:1), and ball milled for 45 hours at 500 r/min in a high-energy ball mill Pulverisette 7 of the German Fritsch Company after sealing. The X-ray diffraction spectrum, electrochemical impedance spectroscopy and direct current polarization spectrum of a low-crystalline Li_{3.25}Zr_{0.75}Mg0.25Cl₆ material after ball milling were shown in FIGS. 38-40, respectively. The results showed that an ionic conductivity at room temperature of the low-crystalline Li_{3.25}Zr_{0.75}Mg_{0.25}Cl₆ material was 1.51×10⁻⁴ S/cm, and an electronic conductivity at room temperature was 1.07×10⁻⁸ S/cm. The ionic conductivity and electronic conductivity were measured by simply cold pressing the battery material into sheets, indicating that the Li_{3.25}Zr_{0.75}Mg_{0.25}Cl₆ material had good deformability; and a fact that the ionic conductivity was four orders of magnitude higher than the electronic conductivity proved that the Li_{3.25}Zr_{0.75}Mg_{0.25} Cl₆ material was a pure ionic conductor that might be used as a solid electrolyte. A transition metal element Zr had combined states of Zr³⁺ and Zr⁴⁺, which had a potential redox ability as a cathode material.

### Embodiment 10

Preparation of a Halogenated All-Solid-State Li_{2.5}Zr_{0.75}Ca_{0.25}Cl₆ Material

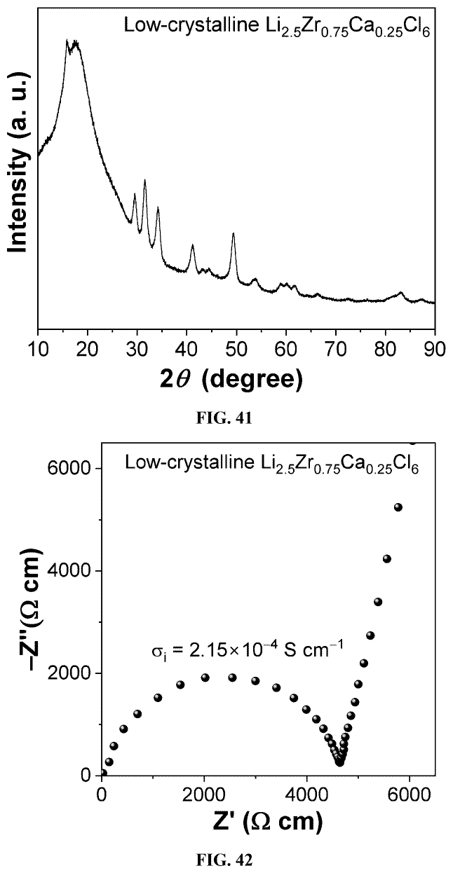

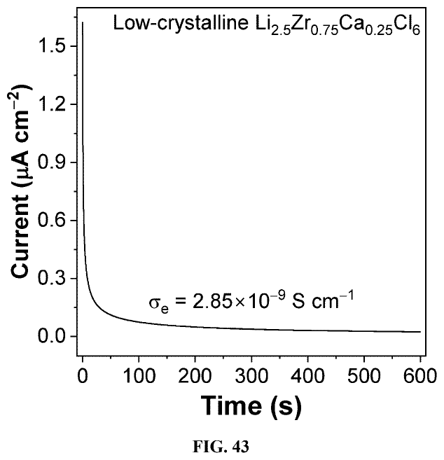

In an argon-protected glove box (a water oxygen content was less than 0.01 ppm), LiCl, ZrCl₄, and CaCl₂ powder were weighed in a stoichiometric ratio, respectively, placed in an 80 mL silicon nitride ball mill tank equipped with 5 mm diameter zirconia ball mill beads (a mass ratio of ball and material was 10:1), and ball milled for 45 hours at 500 r/min in a high-energy ball mill Pulverisette 7 of the German Fritsch Company after sealing. The X-ray diffraction spectrum, electrochemical impedance spectroscopy and direct current polarization spectrum of a low-crystalline Li_{2.5}Zr_{0.75}Ca_{0.25}Cl₆ material after ball milling were shown in FIGS. 41-43, respectively. The results showed that an ionic conductivity at room temperature of the low-crystalline Li_{2.5}Zr_{0.75}Ca_{0.25}Cl₆ material was 2.15×10⁻⁴ S/cm, and an electronic conductivity at room temperature was 2.85×10⁻⁹ S/cm. The ionic conductivity and electronic conductivity were measured by simply cold pressing the battery material into sheets, indicating that the Li_{2.5}Zr_{0.75}Ca_{0.25}Cl₆ material had good deformability; and a fact that the ionic conductivity was five orders of magnitude higher than the electronic conductivity proved that the Li_{2.5}Zr_{0.75}Ca_{0.25}Cl₆ material was a pure ionic conductor that might be used as a solid electrolyte. A transition metal element Zr had combined states of Zr³⁺ and Zr⁴⁺, which had a potential redox ability as a cathode material.

It can be seen from the above embodiments, that the present disclosure provides a halogenated all-solid-state battery material and preparation method and application thereof. The halogenated all-solid-state battery material obtained by the present disclosure not only has an ionic conductivity of up to 1 mS/cm, but also has good deformability, and the M element has a reversible redox ability. The good deformation ability ensures that the battery material can be simply cold pressed into an all-solid-state battery. This battery material, as a positive and negative electrode, no longer needs to add a deformable ion conductive agent that does not provide energy, which can improve the energy density of the battery. At the same time, the high lithium-ion conductivity ensures that the battery has high rate performance.

The above descriptions are merely the preferred embodiments of the present disclosure. It is to be pointed out that for ordinary technical personnel in this technical field, some improvements and embellishments can be made without breaking away from the principle of the present disclosure, and the improvements and embellishments are also to be regarded as the protection scope of the present disclosure.

What is claimed is:

1. A halogenated all-solid-state battery material, wherein a general chemical formula of the halogenated all-solid-state battery material is AₓM_{y}X_{z}Y_{b}, wherein A contains Li or Na; M contains one or more of Mg, Al, Si, P, Ca, Ti, V, Cr, Mn, Fe, Co, Ni, Cu, Zn, Ga, Zr, and Nb; X contains one or more of F, Cl, Br, and I; Y contains O and/or S; and 1≤x≤4, 0.5≤y≤1, 3≤z≤8, and 0≤b≤3.

2. The halogenated all-solid-state battery material according to claim 1, wherein a chemical formula of the halogenated all-solid-state battery material is selected from one of the following chemical formulas:
Li₃TiCl₆, Li₄TiCl₆, Li₃TiCl₅O_{0.5}, Li₃TiCl₅F, Li₃Ti_{0.75}Al_{0.25}Cl₆, Li₄NiCl₆, Li₃ZrCl₆, Li₃Zr_{0.75}Ti_{0.25}Cl₆, Li_{3.25}Zr_{0.75}Mg_{0.25}Cl₆, and Li_{2.5}Zr_{0.75}Ca_{0.25}Cl₆.

3. A preparation method for the halogenated all-solid-state battery material according to claim 1, comprising the following steps:
taking and mixing raw materials with a stoichiometric ratio, and then performing ball milling, to obtain the halogenated all-solid-state battery material.

4. The preparation method for the halogenated all-solid-state battery material according to claim 3, wherein a ball material ratio of the ball milling is (10-15):1, a rotation speed of the ball milling is 500-600 rpm, and a time of the ball milling is 20-50 h.

5. The preparation method for the halogenated all-solid-state battery material according to claim 3, wherein an annealing treatment is performed after the ball milling.

6. The preparation method for the halogenated all-solid-state battery material according to claim 5, wherein a temperature of the annealing treatment is 300-500° C., and a time of the annealing treatment is 4-6 h.

7. A preparation method of an all-solid-state battery, comprising using the halogenated all-solid-state battery material according to claim 1.

8. The preparation method for the halogenated all-solid-state battery material according to claim 3, wherein a chemical formula of the halogenated all-solid-state battery material is selected from one of the following chemical formulas:
Li₃TiCl₆, Li₄TiCl₆, Li₃TiCl₅O_{0.5}, Li₃TiCl₅F, Li₃Ti_{0.75}Al_{0.25}Cl₆, Li₄NiCl₆, Li₃ZrCl₆, Li₃Zr_{0.75}Ti_{0.25}Cl₆, Li_{3.25}Zr_{0.75}Mg_{0.25}Cl₆, and Li_{2.5}Zr_{0.75}Ca_{0.25}Cl₆.

9. The preparation method for the halogenated all-solid-state battery material according to claim 8, wherein a ball material ratio of the ball milling is (10-15):1, a rotation speed of the ball milling is 500-600 rpm, and a time of the ball milling is 20-50 h.

10. The preparation method for the halogenated all-solid-state battery material according to claim 8, wherein an annealing treatment is performed after the ball milling.

11. The preparation method for the halogenated all-solid-state battery material according to claim 4, wherein an annealing treatment is performed after the ball milling.

12. The preparation method for the halogenated all-solid-state battery material according to claim 9, wherein an annealing treatment is performed after the ball milling.

13. The preparation method for the halogenated all-solid-state battery material according to claim 10, wherein a temperature of the annealing treatment is 300-500° C., and a time of the annealing treatment is 4-6 h.

14. The preparation method for the halogenated all-solid-state battery material according to claim 11, wherein a temperature of the annealing treatment is 300-500° C., and a time of the annealing treatment is 4-6 h.

15. The preparation method for the halogenated all-solid-state battery material according to claim 12, wherein a temperature of the annealing treatment is 300-500° C., and a time of the annealing treatment is 4-6 h.

16. The preparation method of the all-solid-state battery according to claim 7, wherein a chemical formula of the halogenated all-solid-state battery material is selected from one of the following chemical formulas:
Li₃TiCl₆, Li₄TiCl₆, Li₃TiCl₅O_{0.5}, Li₃TiCl₅F, Li₃Ti_{0.75}Al_{0.25}Cl₆, Li₄NiCl₆, Li₃ZrCl₆, Li₃Zr_{0.75}Ti_{0.25}Cl₆, Li_{3.25}Zr_{0.75}Mg_{0.25}Cl₆, and Li_{2.5}Zr_{0.75}Ca_{0.25}Cl₆.
